(19) United States
(12) Patent Application Publication
(10) Pub. No.: US 2023/0327839 A1
(43) Pub. Date: Oct. 12, 2023

(54) BASE STATION, WIRELESS COMMUNICATION METHOD, AND WIRELESS COMMUNICATION PROGRAM

(71) Applicant: NIPPON TELEGRAPH AND TELEPHONE CORPORATION, Tokyo (JP)

(72) Inventors: Mitsuki NAKAMURA, Musashino-shi, Tokyo (JP); Wataru YAMADA, Musashino-shi, Tokyo (JP); Yasuhiko INOUE, Musashino-shi, Tokyo (JP); Shoko SHINOHARA, Musashino-shi, Tokyo (JP); Yusuke ASAI, Musashino-shi, Tokyo (JP); Yasushi TAKATORI, Musashino-shi, Tokyo (JP)

(73) Assignee: NIPPON TELEGRAPH AND TELEPHONE CORPORATION, Tokyo (JP)

(21) Appl. No.: 18/022,573

(22) PCT Filed: Aug. 26, 2020
(86) PCT No.: PCT/JP2020/032160

§ 371 Date: Feb. 22, 2023

(51) Int. Cl. H04L 5/00; H04W 72/044; H04W 16/28

(52) U.S. Cl. CPC H04L 5/006; H04W 72/044; H04L 5/0037; H04W 16/28; H04W 84/12

(57) ABSTRACT

A base station according to an embodiment includes an antenna, a wireless device, a wireless information acquisition unit, a control unit, a directivity setting unit, a directivity control unit, and a communication instruction unit. The antenna has an omni-directional array antenna. The wireless device communicates with one or more terminals in a cover area by using a wireless signal via the antenna. The wireless information acquisition unit acquires wireless information including the position of the terminal and a communication time block. On the basis of the wireless information, the control unit determines a communication execution time block, which is a time block for executing communication with the terminal, and an antenna gain of the antenna for communicating with the terminal. On the basis of the antenna gain, the directivity setting unit sets a directivity pattern of the omni-directional array antenna so as to have directivity in the direction of the terminal. On the basis of the directivity pattern, the directivity control unit controls the directivity of the omni-directional array antenna. The communication instruction unit instructs the wireless device to communicate with the terminal in the communication execution time block.

### TECHNICAL FIELD

An embodiment relates to a base station, a wireless communication method, and a wireless communication program.

### BACKGROUND ART

A base station used for wireless LAN communication is preferably configured to be able to communicate with terminals existing in various directions. Therefore, an omni-directional antenna is often used as an antenna used in a base station.

### CITATION LIST

### Patent Literature

[PTL 1] Japanese Patent Application Publication No. 2019-009658

### SUMMARY OF INVENTION

### Technical Problem

In the case of an omni-directional antenna, the gain is smaller than that of the directional antenna. Therefore, it is more difficult for the omni-directional antenna to transmit over a long distance as compared with a directional antennas. In addition, the omni-directional antennas is affected by interfering radio waves more easily.

An embodiment provides a base station that covers a wide area while using an omni-directional antenna and has reduced impact of interference radio waves, and a wireless communication method and a wireless communication program using such a base station.

### Solution to Problem

In the embodiment, the base station includes an antenna, a wireless device, a wireless information acquisition unit, a control unit, a directivity setting unit, a directivity control unit, and a communication instruction unit. The antenna has an omni-directional array antenna. The wireless device communicates with one or more terminals in a cover area by using a wireless signal via the antenna. The wireless information acquisition unit acquires wireless information including the position of a terminal and a communication time block. On the basis of the wireless information, the control unit determines a communication execution time block, which is a time block for executing communication with the terminal, and an antenna gain of the antenna for communicating with the terminal. On the basis of the antenna gain, the directivity setting unit sets a directivity pattern of the omni-directional array antenna so as to have directivity in the direction of the terminal. On the basis of the directivity pattern, the directivity control unit controls the directivity of the omni-directional array antenna. The communication instruction unit instructs the wireless device to communicate with the terminal in the communication execution time block.

### Advantageous Effects of Invention

The embodiment can a base station that covers a wide area while using an omni-directional antenna and has reduced impact of interference radio waves, and a wireless communication method and a wireless communication program using such a base station.

### BRIEF DESCRIPTION OF DRAWINGS

FIG. 1 is a diagram showing an example of a configuration of a wireless system according to an embodiment.

FIG. 2 is a diagram showing an example of a configuration of a base station.

FIG. 3 is a diagram showing an example of a configuration of a terminal 20a.

FIG. 4 is a diagram showing an example of a functional configuration of the base station.

FIG. 5 is a diagram showing an example of a functional configuration of the terminal 20a.

FIG. 6 is a flowchart showing an example of a learning operation at the base station.

FIG. 7 is a flowchart showing an example of a communication operation after learning in the base station.

FIG. 8 is a flowchart showing an example of a communication operation at the terminal 20a.

### DESCRIPTION OF EMBODIMENTS

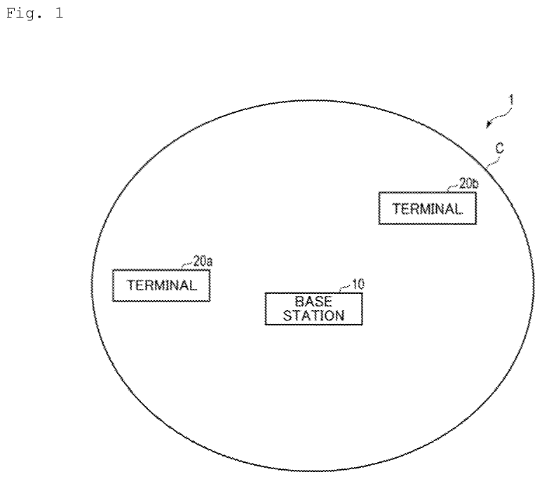

Embodiments will be described hereinafter with reference to the drawings. FIG. 1 shows an example of a configuration of a wireless system 1 according to an embodiment. As shown in FIG. 1, the wireless system 1 includes, for example, a base station 10 and a terminal 20a. The terminal 20a exists within a cover area C of the base station 10. Furthermore, a terminal 20b which can be an interference source when the base station 10 and the terminal 20a communicates with each other exists in the cover area C of the base station 10. In the following, although the interference source is the terminal 20b, the terminal 20a, too, can be an interference source when the base station 10 and the terminal 20b communicates with each other. That is, the following explanation can hold true even if the terminal 20a and the terminal 20b are replaced with each other.

The base station 10 is a wireless communication device used as an access point for a wireless LAN. For example, the base station 10 can wirelessly transmit, to the terminal 20a, data received from a server via a network, not shown. The base station 10 can also receive data wirelessly from the terminal 20a. Communication between the base station 10 and the terminal 20a is based on, for example, the IEEE 802.11 standard.

The terminal 20a is a terminal provided with a wireless communication device, such as a smartphone, or a tablet PC. The terminal 20a may be an immobile terminal provided with a wireless communication device, such as a desktop computer. The terminal 20a may be capable of communicating with at least the base station 10. FIG. 1 shows only one terminal 20a. A plurality of terminals 20a may exist in the cover area C of the base station 10.

The terminal 20b is a terminal provided with a wireless communication device, such as a smart phone or a tablet PC, and is, for example, a terminal handling traffic different from the terminal 20a. The terminal 20b may be an immobile terminal provided with a wireless communication device, such as a desktop computer. The terminal 20b may be capable of communicating with at least the base station 10. FIG. 1 shows only one terminal 20b. A plurality of terminals 20b may exist in the cover area C of the base station 10. In addition, in FIG. 1, the interference source is the terminal 20b. On the other hand, the interference source in communication with the terminal 20a does not necessarily have to be a terminal. The interference source may be, for example, a base station different from the base station 10. The interference source in the embodiment may be any interference source capable of communicating with the base station 10.

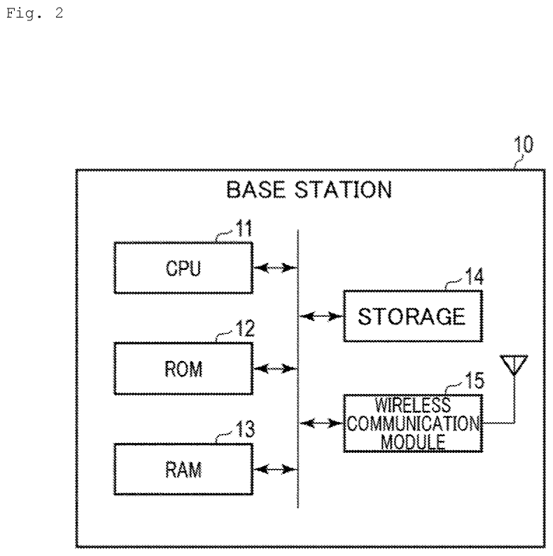

FIG. 2 shows an example of a configuration of the base station 10. As shown in FIG. 2, the base station 10 includes, for example, a CPU (Central Processing Unit) 11, a ROM (Read Only Memory) 12, a RAM (Random Access Memory) 13, a storage 14, and a wireless communication module 15. The base station 10 may be provided with a wired communication module or the like for communication connection with a server, not shown.

The CPU 11 is a circuit capable of executing various programs, and controls an overall operation of the base station 10. An ASIC or the like may be used instead of the CPU. Also, the number of CPUs 11 is not limited to one; there may be two or more CPUs 11. The ROM 12 is a non-volatile semiconductor memory, and holds a program, control data, and the like for controlling the base station 10. The RAM 13 is, for example, a volatile semiconductor memory and is used as a work area of the CPU 11. The storage 14 is a nonvolatile storage device such as a flash memory, and holds system software and the like of the base station 20. The storage 14 also holds a learning result described hereinafter. The wireless communication module 15 is a circuit used for transmitting and receiving data by a wireless signal, and is connected to an antenna. As will be described later, the antenna in the embodiment is an omni-directional array antenna.

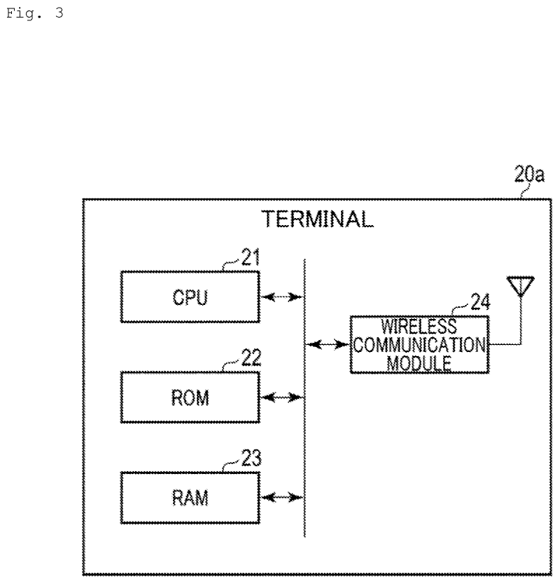

FIG. 3 shows an example of a configuration of the terminal 20a. The terminal 20b may or may not have the same configuration as the terminal 20a. The following describes a case where the terminal 20b has the same configuration as the terminal 20a; the description of the configuration of the terminal 20b is omitted accordingly. As shown in FIG. 3, the terminal 20a includes, for example, a CPU 21, a ROM 22, a RAM 23, and a wireless communication module 24.

The CPU 21 is a circuit capable of executing various programs, and controls an overall operation of the terminal 20a. An ASIC or the like may be used instead of the CPU. Also, the CPU 21 is not limited to one, and may be two or more. The ROM 22 is a non-volatile semiconductor memory, and holds a program, control data, and the like for controlling the terminal 20a. The RAM 23 is, for example, a volatile semiconductor memory and is used as a work area of the CPU 21. The wireless communication module 24 is a circuit used for transmitting and receiving data by a wireless signal, and is connected to an antenna. The antenna of the terminal 20a is not particularly limited.

The wireless system 1 executes data communication on the basis of, for example, the OSI (Open Systems Interconnection) reference model. Communication functions in the OSI reference model are divided into seven layers (first layer: physical layer, second layer: data link layer, third layer: network layer, fourth layer: transport layer, fifth layer: session layer, sixth layer: presentation layer, and seventh layer: application layer). The data link layer includes, for example, an LLC (Logical Link Control) layer and a MAC (Media Access Control) layer.

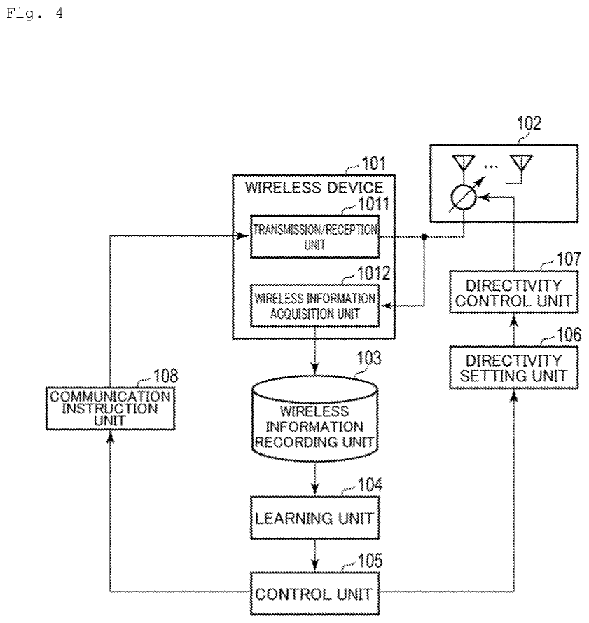

FIG. 4 shows an example of a functional configuration of the base station 10. As shown in FIG. 4, the base station 10 includes, for example, a wireless device 101, an antenna 102, a wireless information recording unit 103, a learning unit 104, a control unit 105, a directivity setting unit 106, a directivity control unit 107, and a communication instruction unit 108. The wireless device 101 and the antenna 102 correspond to, for example, the wireless communication module 15. The wireless information recording unit 103 corresponds to, for example, the storage 14. The learning unit 104, the control unit 105, the directivity setting unit 106, the directivity control unit 107, and the communication instruction unit 108 are implemented, by, for example, the CPU 11 executing a wireless communication program stored in the ROM 12.

The wireless device 101 performs processing related to transmission/reception of wireless signals. The wireless device 101 includes a transmission/reception unit 1011 and a wireless information acquisition unit 1012. Here, the wireless device 101 may include a plurality of wireless devices for handling wireless signals of different channels.

The transmission/reception unit 1011 transmits/receives a wireless signal according to an instruction from the communication instruction unit 108. For example, when transmitting a wireless signal, the transmission/reception unit 1011 generates a wireless signal from data that is input from a server or the like, not shown, receives the wireless signal, and transmits the wireless signal to the terminal 20a via the antenna 102. Also, when receiving the wireless signal, the transmission/reception unit 1011 restores data from the wireless signal received from the terminal 20a via the antenna 102.

The wireless information acquisition unit 1012 acquires wireless information of each of the terminal 20a, which is a communication partner of the base station 10, and the terminal 20b, which is an interference source. The wireless information includes an identifier of each terminal, a communication time block, positions of the terminals, and a traffic amount in communication. The communication time block is a time block in which communication with a corresponding terminal is performed. The communication time block is measured from, for example, the communication time from the start to the completion of communication. The positions of the terminals are the positions of the terminals in the cover area C. The positions of the terminals are measured from, for example, the reception signal strength (RSSI) of the radio wave of a wireless signal and the direction of arrival of the radio wave. The RSSI is measured from, for example, received power of a wireless signal. The direction of arrival of the radio wave is measured from, for example, a phase difference between wireless signals received by respective antenna elements constituting an omni-directional array antenna. The traffic amount is the data amount of a wireless signal transmitted within a fixed period. The traffic amount is measured from, for example, RSSI.

The antenna 102 is an antenna provided with an antenna element for transmitting and receiving wireless signals. The antenna 102 in the embodiment is an omni-directional array antenna having a plurality of omni-directional antenna elements. By controlling the amplitude and phase of each omni-directional antenna element, the antenna 102 can operate as an antenna with directivity.

Wireless information related to each of the terminals 20a and 20b acquired by the wireless information acquisition unit 1012 is recorded in the wireless information recording unit 103. The wireless information is recorded for each terminal.

The learning unit 104 learns the correspondence relationship between the positions of the terminals 20a and 20b in the cover area C and the communication time block of each terminal on the basis of the wireless information recorded in the wireless information recording unit 103. Here, the learning unit 104 does not necessarily have to be provided in the base station 10. The learning unit 104 may be provided in a server or the like capable of communicating with the base station 10.

The control unit 105 performs grouping of terminals 20a on the basis of a learning result of the learning unit 104. A group of terminals 20a includes at least one terminal 20a. The control unit 105 also assigns a communication execution time block for each group of terminals 20a on the basis of a learning result of the learning unit 104. The communication execution time block is a time block for communicating with the group of terminals 20a. Then, the control unit 105 notifies the communication instruction unit 108 of the communication execution time block. Also, the control unit 105 determines a condition for antenna gain in each direction of the antenna 102 for communicating with the group of terminals 20a in the communication execution time block. Then, the control unit 105 notifies the directivity setting unit 106 of the determined antenna gain condition.

The directivity setting unit 106 sets a directivity pattern satisfying the antenna gain condition notified by the control unit 105. The directional pattern includes the amplitude and phase of each omni-directional antenna element constituting the antenna 102.

The directivity control unit 107 controls the directivity of the antenna 102 on the basis of the directivity pattern set by the directivity setting unit 106.

The communication instruction unit 108 instructs the transmission/reception unit 1011 of the wireless device 101 to execute communication when the communication execution time block notified by the control unit 105 comes. The communication instruction unit 108 also provides the terminal 20a with the communication execution time block notified by the control unit 105. The instruction about a communication execution time block is provided to the terminal 20a by using the transmission/reception unit 1011.

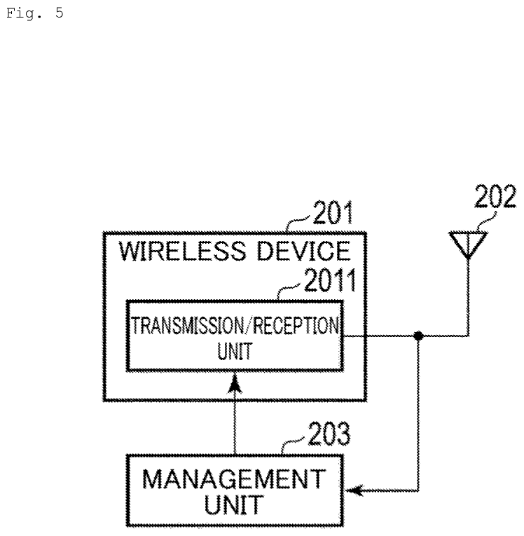

FIG. 5 shows an example of a functional configuration of the terminal 20a. As shown in FIG. 5, the terminal 20a includes, for example, a wireless device 201, an antenna 202, and a management unit 203. The wireless device 201 and the antenna 202 correspond to, for example, the wireless communication module 24. The management unit 203 is implemented by, for example, the CPU 21 executing a wireless communication program stored in the ROM 22.

The wireless device 201 performs processing related to communication by a wireless signal. Here, the wireless device 201 handles a wireless signals of the same channel as the wireless device 101. The wireless device 201 includes a transmission/reception unit 2011.

The transmission/reception unit 2011 transmits and receives a wireless signal according to an instruction from the management unit 203. For example, when transmitting a wireless signal, the transmission/reception unit 2011 generates a wireless signal from input data, receives the wireless signal, and transmits the wireless signal to the base station 10 via the antenna 202. When receiving the wireless signal, the transmission/reception unit 2011 restores data from the wireless signal received from the base station 10 via the antenna 202.

The antenna 202 is an antenna provided with an antenna element for transmitting and receiving wireless signals. The antenna 202 is not particularly limited. For example, the antenna 202 may have a single antenna element or a plurality of antenna elements. The antenna 202 may be an omni-directional antenna or a directional antenna.

The management unit 203 manages a communication time block of the wireless device 201. For example, when the communication execution time block is not notified from the base station 10, the management unit 203 allows the wireless device 201 to communicate with the base station 10. On the other hand, when the communication execution time block is notified from the base station 10, the management unit 203 allows the wireless device 201 to communicate with the base station 10 when the communication time block comes.

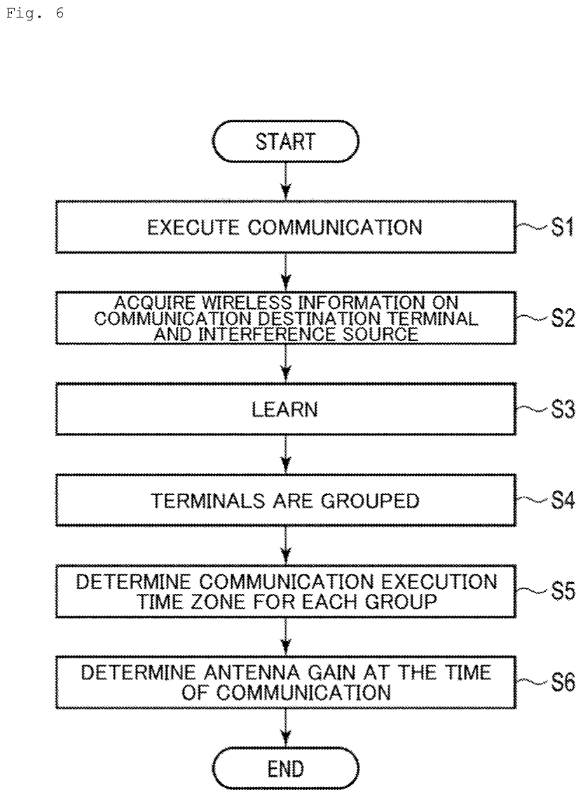

Operations in the wireless system 1 are now described next. An operation of the base station 10 is described first. The operation of the base station 10 is divided into a learning operation and a communication operation. FIG. 6 is a flowchart showing an example of the learning operation performed by the base station 10. The base station 10 learns the correspondence relationship between the positions each of the terminals 20a and 20b in the cover area C and the communication time block of the same while communicating with the terminal 20a, which is a communication partner, and the terminal 20b, which is an interference source. The base station 10 then communicates with the terminal 20a by using the learning result. The processing shown in FIG. 6 is periodically executed every hour, every day, every week, every month, or the like.

In step S1, the base station 10 performs communication with the terminal 20a or the terminal 20b. The communication may be transmission of a wireless signal including data from the base station 10, or reception of a wireless signal including data from the terminal 20a or 20b. In addition, the communication may be transmission of a beacon signal from the base station 10. When transmitting a beacon signal, the antenna 102 is controlled to operate as an omni-directional antenna even after the learning operation. This is because the beacon signal needs to be detected in each terminal in the cover area C. Here, a wireless signal and a beacon signal for transmitting and receiving data can be identified by a frame type recorded in a header of a MAC frame included in the wireless signal.

In step S2, the base station 10 acquires wireless information in the communication in step S1. As described above, the wireless information includes the identifiers of the terminals, the communication time block for communicating with the terminals, the positions of the terminals, and the traffic amount.

In step S3, the base station 10 records the wireless information, and learns the correspondence relationship between the position of each terminal in the cover area and the communication time block on the basis of the recorded wireless information. The learning method for learning the correspondence relationship between the positions of the terminals and the communication time block is not limited to a specific method. For example, various types of multi-value classification learning can be used for this learning. Here, the processing of steps S4 to S6 may not be performed until a certain amount of learning is performed in step S3.

In step S4, the base station 10 performs grouping of terminals 20a on the basis of the learning result. Specifically, the base station 10 classifies a plurality of terminals 20a in close proximity into one group. There may be only one terminal 20a included in the group. The base station 10 may classify a plurality of terminals 20a that are similar in position as well as communication time block and type of traffic being communicated, into one group. The number of terminals 20a belonging to one group may be determined by the traffic amounts of the terminals 20a belonging to the group. For example, the number of terminals 20a belonging to one group may be determined so that the total traffic amount for each group is a predetermined value. In this case, if the traffic amount of each terminal 20a is small, the number of terminals 20a belonging to one group increases. On the contrary, if the traffic amount of each terminal 20a is large, the number of terminals 20a belonging to one group decreases.

In step S5, the base station 10 assigns communication execution time block. Specifically, the base station 10 assigns the same communication execution time block for a group having close communication time block, on the basis of the learning result. On the other hand, when a terminal 20b as an interference source to the group of the terminals 20a exists in the same direction as the group of terminals 20a, the base station 10 assigns communication execution time block so that the communication execution time block varies between the group of terminals 20a and the terminal 20b. For example, when the terminal 20b always performs communication in the same communication time block, the base station 10 assigns a communication execution time block of each group of terminals 20a so as to avoid the communication time block of the terminal 20b. On the other hand, when the terminal 20b does not always perform communication in the same communication time block, the base station 10 assigns the communication execution time block of the terminal 20b so as to avoid the communication execution time block of each group of terminal 20a.

In step S6, the base station 10 determines an antenna gain for communication with the group of terminals 20a in the communication execution time block on the basis of the learning result. Specifically, the base station 10 increases the antenna gain in the direction in which the group of terminals 20a exists, and decreases the antenna gain in the direction in which the interference source such as the terminal 20b exists. Furthermore, the base station 10 may reduce the antenna gain not only in the direction in which the interference source such as the terminal 20b exists but also in the direction in which the group of terminals 20a does not exist. Here, the RSSI may also be considered when determining the antenna gain.

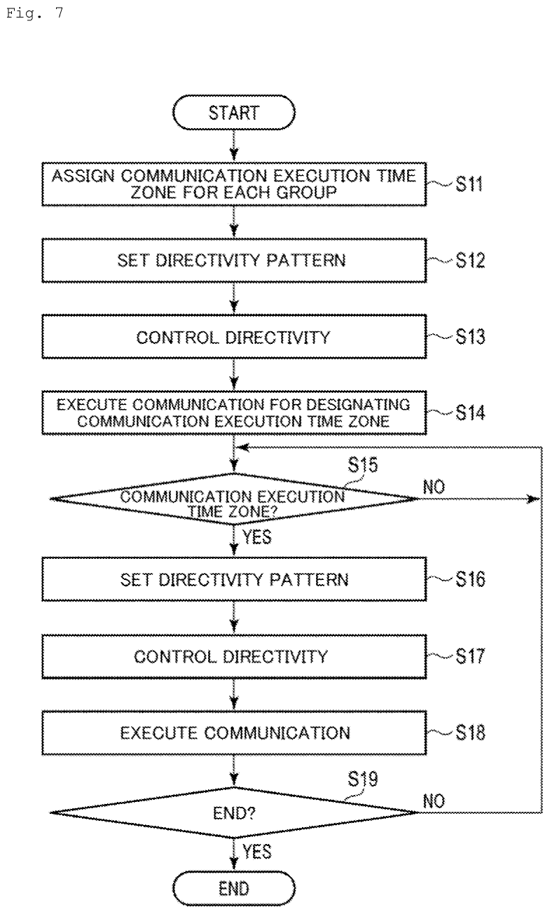

FIG. 7 is a flowchart showing an example of the communication operation performed by the base station 10 after learning. In step S11, the base station 10 assigns a communication execution time block for each group of terminals 20a according to the learning result.

In step S12, the base station 10 sets a directivity pattern. In step S12, a directivity pattern is set in such a manner that the antenna 102 operates as an omni-directional antenna.

In step S13, the base station 10 controls the directivity of the antenna 102 on the basis of the set directivity pattern.

In step S14, the base station 10 executes communication for notifying of a communication execution time block. For example, the base station 10 transmits a beacon signal including the communication execution time block of each group of terminals 20a and the communication execution time block of the terminal 20b which is an interference source. Since the directivity of the antenna 102 is controlled in such a manner that the antenna 102 operates as an omni-directional antenna, the beacon signal can be received by each of the terminals 20a and the terminal 20b in the cover area C. After receiving response signals from each terminal 20a and the terminal 20b, the processing moves to step S15. In step S14, the communication execution time block are not necessarily notified by the beacon signal. For example, the communication execution time block may be notified by communication of an individual wireless signal with each terminal.

In step S15, the base station 10 determines whether or not the communication execution time block assigned to a group of terminals 20a has come. In step S15, the processing is held up until the communication execution time block comes. The directivity pattern may be set so that the antenna 102 operates as an omni-directional antenna until the communication execution time block comes. Since the antenna 102 operates as an omni-directional antenna, the base station 10 can receive a wireless signal from each direction. When it is determined in step S15 that the communication execution time block has come, the processing proceeds to step S16.

In step S16, the base station 10 sets a directivity pattern so as to have directivity to the direction of the group of terminals 20a corresponding to the current communication execution time block. In step S16, the directivity pattern is set so that the antenna gain in the direction of a group of terminals 20a performing communication in the current communication execution time block becomes high. When the terminal 20b exists as an interference source, the directivity pattern is set so that the antenna gain in the direction of the terminal 20b becomes lower.

In step S17, the base station 10 controls the directivity of the antenna 102 on the basis of the set directivity pattern.

In step S18, the base station 10 performs communication with a group of terminals 20a. For example, the base station 10 transmits a wireless signal to the group of terminals 20a. The base station 10 receives a wireless signal from the group of terminals 20a. After the execution of the communication, the processing then moves to step S19.

In step S19, the base station 10 determines whether to end the communication. For example, when communication with all groups of terminals 20a to which communication execution time block are assigned is executed, it is determined that the communication is ended. If it is determined in step S19 that the communication is not ended, the processing returns to step S15. If it is determined in step S19 that the communication is to be ended, the base station 10 ends the processing of FIG. 7.

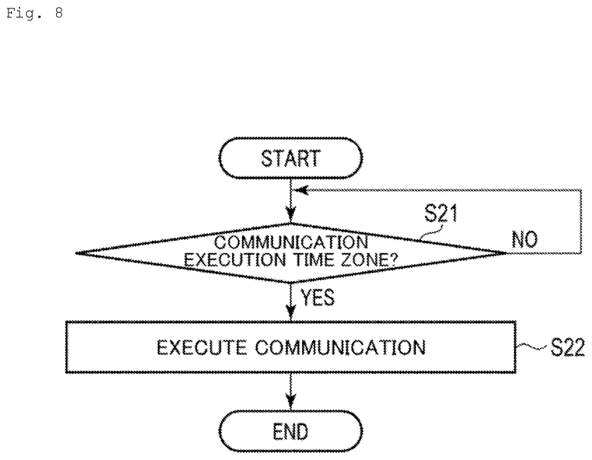

FIG. 8 is a flowchart showing an example of a communication operation of the terminal 20a. Here, it is assumed that the terminal 20a is notified of the communication execution time block from the base station 10. The operation of the terminal 20a will be described hereinafter, but the operation of the terminal 20b may be performed in the same manner as the terminal 20a.

In step S21, the terminal 20a determines whether or not the communication execution time block notified from the base station 10 has come. In step S21, the processing is held up until the communication execution time block comes. The terminal 20a may communicate with a base station other than the base station 10 until the communication execution time block comes. When it is determined in step S21 that the communication execution time block has come, the processing proceeds to step S22.

In step S22, the terminal 20a performs communication with the base station 10. For example, the terminal 20a transmits a wireless signal to the base station 10. The terminal 20a also receives a wireless signal from the base station 10. After the communication is executed, the terminal 20a ends the processing shown in FIG. 8.

According to the embodiment described above, the directivity of the antenna is controlled by controlling the amplitude and phase of each omni-directional antenna element of the omni-directional array antenna. Furthermore, a communication execution time block to be assigned to each terminal is determined on the basis of a correspondence relationship between the position of a terminal in the cover area of the base station and the communication time block of each terminal. Then, a beam with directivity is directed toward the terminal which is a communication partner, for each communication execution time block. Thus, although an omni-directional array antenna is used, the antenna gain is improved. Therefore, in the embodiment, long-distance transmission is possible while using an omni-directional array antenna, and as a result, the cover area of the base station 10 can be expanded. Moreover, since the antenna gain is reduced in a direction other than the terminal which is the communication partner, the impact of interference radio waves arriving from other directions is reduced.

The communication time execution zone of the terminal which is the communication partner is set so as to avoid the communication time block of the terminal which is an interference source. Thus, the impact of interference radio waves arriving from directions other than the group of communication partners is further reduced.

Terminals as communication partners are grouped according to the positions and traffic amounts thereof, and communication is performed for each group. Thus, the total traffic amount in each communication time block can be suppressed to a certain fixed value.

Here, in the embodiment, different communication execution time block are assigned to the terminal 20a and the terminal 20b in order to suppress the arrival of interference radio waves from the terminal 20b which is an interference source. On the other hand, the arrival of interference radio waves by the terminal 20b can also be suppressed by causing the terminal 20b to perform carrier sense during the communication execution time block of the terminal 20a. Assigning different communication execution time block for the terminals 20a and 20b and causing the terminal 20b to perform carrier sensing during the communication execution time block of the terminal 20a may be used together.

In the embodiment, the correspondence relationship between the positions of terminals in the cover area of the base station and the communication time block of each terminal is learned, and the communication time block assigned to each terminal and the antenna gain condition are determined based on the learning result. On the other hand, the communication time block assigned to each terminal and the antenna gain condition may be determined more simply based on various statistical values such as the average value of the positions of the terminals and the average value of the communication time block. In addition, when the terminals 20a are immobile terminals and the communication time block are constant, the communication time block assigned to each terminal and the antenna gain condition may be determined without obtaining the correspondence relationship.

Each processing described in the embodiment can also be stored as a program that can be executed by a CPU or the like that is a computer. The program can also be stored in a storage medium of an external storage device such as a magnetic disk, an optical disk, or a semiconductor memory, or the like, and distributed. The CPU or the like can then execute the above-described processing by reading in the program stored in the storage medium of the external storage device, and actions thereof being controlled by the program read in.

The present invention is not limited to the embodiments described above and can variously be modified at an execution stage within a scope not departing from the gist thereof. The embodiments may also be combined appropriately to be implemented, and in that case, combined effects can be obtained. In addition, the embodiments described above include various inventions, and the various inventions can be extracted by combinations selected from a plurality of disclosed constituent elements. For example, even when some of all the constituent elements disclosed in the embodiments are deleted, as long as the problems can be solved and the effects can be obtained, a configuration from which the constituent elements are deleted can be extracted as an invention.

### REFERENCE SIGNS LIST

1 Wireless system

10 Base station

11 CPU

12 ROM

13 RAM

14 Storage

15 Wireless communication module

20a, 20b Terminal

21 CPU

22 ROM

23 RAM

24 Wireless communication module

101 Wireless device

102 Antenna

103 Wireless information recording unit

104 Learning unit

105 Control unit

106 Directivity setting unit

107 Directivity control unit

108 Communication instruction unit

201 Wireless device

202 Antenna

203 Management unit

1011 Transmission/reception unit

1012 Wireless information acquisition unit

2011 Transmission/reception unit

1. A base station, comprising: an antenna that has an omni-directional array antenna; a wireless device that communicates with one or more terminals in a cover area by a wireless signal via the antenna; a wireless information acquisition unit that acquires wireless information including a position of the terminal and a communication time block; a control unit that determines a communication execution time block, which is a time block in which communication with the terminal is executed, and an antenna gain of the antenna for communicating with the terminal, on the basis of the wireless information; a directivity setting unit that sets a directivity pattern of the omni-directional array antenna so as to have directivity in a direction of the terminal, on the basis of the antenna gain; a directivity control unit that controls directivity of the omni-directional array antenna based on the directivity pattern; and a communication instruction unit that instructs the wireless device to communicate with the terminal in the communication execution time block.

2. The base station according to claim 1, wherein the wireless information acquisition unit further acquires, as the wireless information, a position of an interference source and a communication time block when the wireless signal is transmitted and received between the wireless device and the terminal, and the control unit determines the antenna gain so as to increase a first antenna gain with respect to the direction of the terminal and to reduce a second antenna gain with respect to a direction of the interference source, and determines the communication execution time block so as to avoid a communication time block of the interference source.

3. The base station according to claim 1, wherein the control unit determines the antenna gain and the communication execution time block based on a correspondence relationship between a position of the terminal and a communication time block of the terminal that are learned based on the wireless information.

4. The base station according to claim 1, wherein two or more of the terminals exist, the wireless information acquisition unit further acquires a traffic amount of communication with each of the terminals as the wireless information, and the control unit groups two or more of the terminals on the basis of a position and a traffic amount of each of the terminals and determines the antenna gain and the communication execution time block for each group of the terminals.

5. The base station according to claim 4, wherein the control unit determines the terminal included in one group so that a total amount of the traffic amount for each group of terminals becomes a predetermined value.

6. A wireless communication method by a base station that communicates with one or more terminals in a cover area by using an antenna having an omni-directional array antenna, the wireless communication method comprising:
acquiring wireless information including a position of the terminal and a communication time block; determining a communication execution time block, which is a time block in which communication with the terminal is executed, and an antenna gain of the antenna for communicating with the terminal, on the basis of the wireless information; setting a directivity pattern of the omni-directional array antenna so as to have directivity in a direction of the terminal, on the basis of the antenna gain; controlling directivity of the omni-directional array antenna based on the directivity pattern; and communicating with the terminal in the communication execution time block.

7. A wireless communication program for causing a processor to function as the wireless information acquisition unit, the control unit, the directivity setting unit, the directivity control unit, and the communication instruction unit of the base station according to claim 1.
